(19) United States
(12) Patent Application Publication
(10) Pub. No.: US 2023/0022944 A1
(43) Pub. Date: Jan. 26, 2023

(54) HEAVY DUTY EXPANDABLE BEARING PULLER

(71) Applicant: Gary Kendrick, Alabaster, AL (US)

(72) Inventor: Gary Kendrick, Alabaster, AL (US)

(21) Appl. No.: 17/381,102

(22) Filed: Jul. 20, 2021

(51) Int. Cl. B25B 27/06

(52) U.S. Cl. CPC B25B 27/06

(57) ABSTRACT

In an embodiment of the disclosed principles, a bearing extraction tool is provided having a threaded rod, an expansion sleeve over a portion of the threaded rod and a multi-segment expansion head between the expansion sleeve and a bottom end of the threaded rod. The threaded rod bottom end includes an expansion plug having a ramped shoulder, a trunk and a stop. The expansion sleeve includes a ramped shoulder facing the ramped shoulder of the expansion plug. The outermost diameter of the expansion head occurs at a ledge portion of the expansion head. The ledge portion is small enough to fit through the central opening of a bearing to be extracted. When the two shoulders are then pushed towards one another, the ramped shoulders expand the expansion head, locking the ledge portion behind the bearing. Subsequent outward movement of the tool via a threaded fitting on the threaded rod moves the bearing outward for extraction.

### TECHNICAL FIELD

The present disclosure is related generally to the removal of annular mechanical parts from within fitted cavities and, more particularly, in an embodiment of the described principles, to an internally expandable puller collar and method for using same.

### BACKGROUND

In the mechanical arts, practitioners are often required to remove an annular part such as a bearing or bearing race without access to a graspable external element. For example, a bearing assembly having an exposed side and a hidden side may be press fit into a bearing cavity by applying external pressure on the exposed side of the bearing assembly. However, when the bearing must later be removed, there is no access for the mechanic to apply outward pressure on the hidden side of the bearing.

One method that has developed in the art for solving this problem is the slide hammer and jaw set. This device is rod-shaped with a hammer that slides along the rod until it strikes a slide end. This impact pulls the rod outward with some force. In practice, a portion of the rod is run through the bearing assembly and the jaws of the jaw set are hooked behind it. Subsequent hammering via the slide may eventually dislodge the bearing assembly.

However, the jaws have very little contact surface touching the part being pulled, and the tips of these jaws are the weakest part. Moreover, it can be difficult during use to keep the device parallel with the part to be pulled, and since the jaws are the only contact surface, the jaws tend to break if the tool becomes unaligned during a swing of the hammer. Moreover, the jaw set attached to the slide hammer sometimes slips out while trying to pull the part, possibly damaging the inside of the part.

The improvement described herein provides a better solution that provides a greater contact area that requires less exertion and is less likely to damage the tool, the extracted bearing or the larger part. However, before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a bearing extraction tool is disclosed having a threaded rod, an expansion sleeve over a portion of the threaded rod and a multi-segment expansion head between the expansion sleeve and a bottom end of the threaded rod. The threaded rod bottom end includes an expansion plug having a ramped shoulder, a trunk and a stop. The expansion sleeve includes a ramped shoulder facing the ramped shoulder of the expansion plug. The outermost diameter of the expansion head occurs at a ledge portion of the expansion head.

In a relaxed state, the ledge portion is small enough to fit through the central opening of a bearing to be extracted. However, when the two shoulders are pushed towards one another, the ramped shoulders expand the expansion head such that a ledge portion of the expansion head exceeds the inner diameter of the target bearing, locking the ledge portion behind the bearing. Outward movement of the tool now serves to also move the bearing outward for extraction. In an embodiment, the outward movement of the tool is provided via a threaded nut threaded onto the threaded portion of the threaded rod and against a brace such as a bracket or washer.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a perspective representation of a bearing extraction assembly in accordance with an embodiment of the disclosed principles, with the extraction assembly head not yet expanded;

FIG. 2 is a perspective representation of the bearing extraction assembly in accordance with an embodiment of the disclosed principles, with the extraction assembly head expanded;

FIG. 3A is an end view of the bearing extraction assembly head in a non-expanded configuration in accordance with an embodiment of the disclosed principles;

FIG. 3B is an end view of the bearing extraction assembly head in an expanded configuration in accordance with an embodiment of the disclosed principles;

FIG. 4A is a cross-sectional view of the bearing extraction assembly in accordance with an embodiment of the disclosed principles, with the extraction assembly head not expanded;

FIG. 4B is a cross-sectional view of the bearing extraction assembly in accordance with an embodiment of the disclosed principles, with the extraction assembly head expanded;

FIG. 5A is a perspective side view of the bearing extraction assembly and a target bearing in accordance with an embodiment of the disclosed principles, with the extraction assembly outside the bearing and the extractor head not expanded;

FIG. 5B is a perspective side view of the bearing extraction assembly and a target bearing in accordance with an embodiment of the disclosed principles, with the extraction assembly through the bearing but the extractor head not expanded;

FIG. 5C is a perspective side view of the bearing extraction assembly and a target bearing in accordance with an embodiment of the disclosed principles, with the extraction assembly through the bearing and the extractor head expanded; and

FIG. 6 is a flow chart showing a process of using a bearing extractor assembly in in accordance with an embodiment of the disclosed principles.

### DETAILED DESCRIPTION

As noted above, removing a press fit annular part such as a bearing or bearing race from a cavity presents a common challenge for mechanics. Although a slide hammer and jaw set may sometimes enable removal of such a piece, the jaws have very little contact surface touching the part being pulled, and the tips of these jaws are the weakest part. Since it can be difficult during use to keep the device parallel with the part to be pulled, and since the jaws are the only contact surface, the jaws tend to break if the tool becomes unaligned during a swing of the hammer.

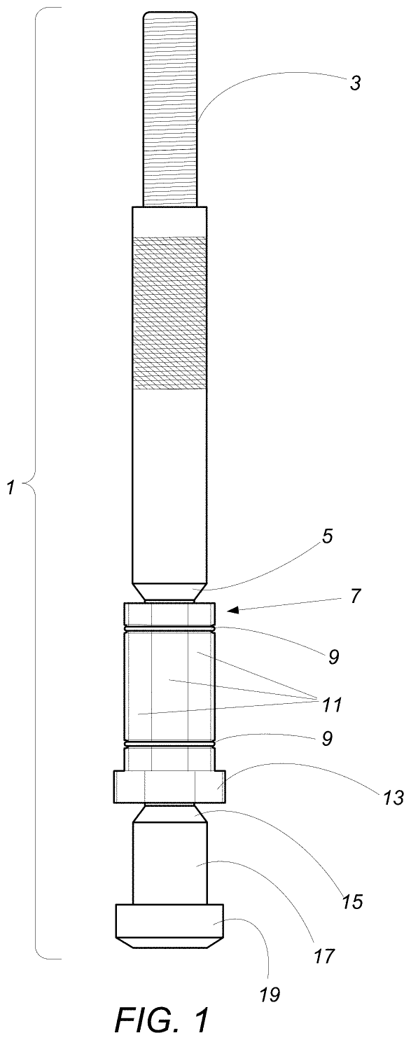

With this overview in mind, we turn now to a more detailed discussion of the disclosed principles in conjunction with the attached figures. Turning more specifically to the figures, FIG. 1 is a perspective representation of a bearing extraction assembly in accordance with an embodiment of the disclosed principles, with the extraction assembly head not yet expanded.

As shown in the illustrated example, the extraction assembly 1 includes a central threaded rod 3, terminating in an expansion plug comprising a shoulder 15, a trunk 17 and a stop 19. The shoulder 15 is substantially linearly ramped between the diameter of the threaded rod 3 and the larger diameter of the trunk 17. An expansion sleeve 5 with a similar ramped shoulder has an internal passage of slightly greater than the threaded rod 3 and is slid over the rod 2. An expansion head 7 is also slid over the threaded rod 3 and is situated, at rest, between the shoulders of the terminating expansion plug and the sleeve 5.

The expansion head 7 in the illustrated example is comprised of multiple parallel segments surrounded by retention bands 9 that keep the segments together while allowing expansion under force. The bands 9 may be metallic, elastomeric or other type of flexible or stretchable material. Although the number of segments may range from two to any number, the illustrated examples herein include 6 to 8 segments. The expansion head 7 includes a head ledge 13. In the at rest position, the internal diameter of the expansion head 7 is slightly greater than the threaded rod diameter, and the external diameter of the head ledge 13 (which is always greater than the remainder of the head 7) is less than the internal most diameter of the part to be removed.

In its expanded state, the internal diameter of the expansion head 7 expands to the diameter of the sleeve 7 and the trunk 17. Importantly, the outer diameter of the main portion of the head 7 expands in the expanded state to approximately match the internal most diameter of the part to be removed. In this configuration, the external diameter of the head ledge 13 exceeds the internal most diameter of the part to be removed, and thus provides an interference fit of the assembly 1 in the part to be removed.

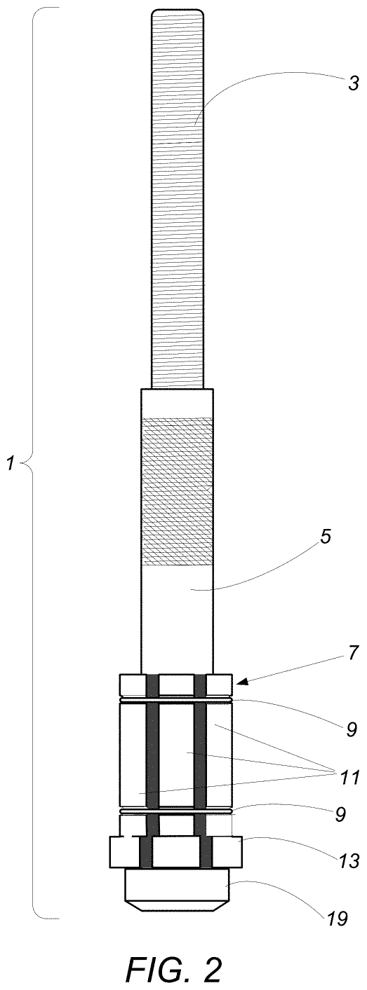

Turning to FIG. 2, this figure shows a perspective representation of the bearing extraction assembly again, but with the sleeve 5 slid down the threaded rod 3 such that the shoulders of the sleeve 5 and extraction stop pushed together, thus expanding the expansion head 7. In this configuration, the retention bands 9 provide sufficient force to keep the segments of the expansion head 7 against the sleeve 5 and the trunk 17 of the extraction stop.

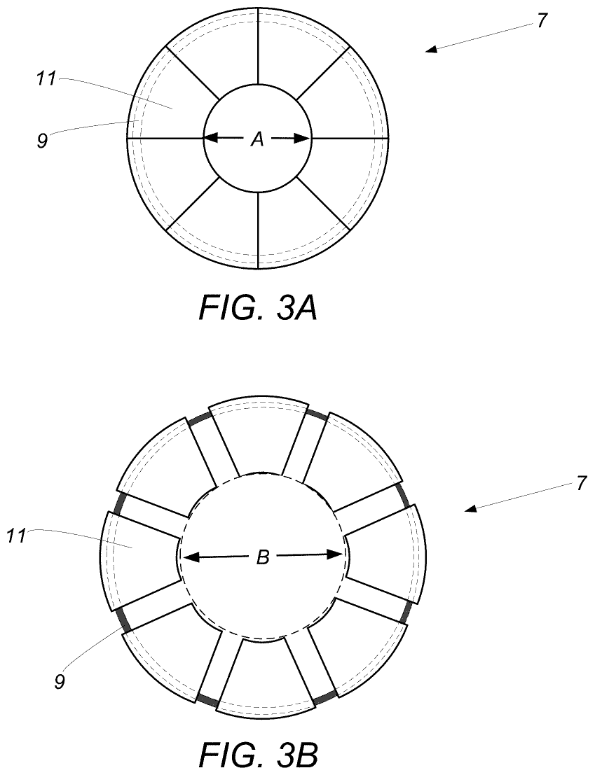

FIGS. 3A and 3B provide end views of the expansion head 7. In FIG. 3A, the expansion head 7 is shown in a non-expanded configuration, whereas in FIG. 3B, the expansion head 7 is shown in its larger expanded configuration. The retention bands 9 can also be seen, sitting in a groove on the surface of the expansion head 7.

The outer diameter of the ledge 13 of the expansion head 7 is preferably substantially as large as possible while still being able to pass through the center of the bearing or other part being pulled when the expansion head 7 is in non-expanded form. Similarly, the outer diameter of the non-ledge portion of the head 7 should be sized to snuggly fit the center of the bearing or other part being pulled when the expansion head 7 is in expanded form.

This sizing will ensure the most surface for the expansion plug stop 19 to pull against during extraction while preventing any of the segments 11 from pivoting within the part being extracted. Because of this, in an embodiment, the expansion head 7, expansion plug 18 and possibly the expansion sleeve 5 are provided as a set for each required inner part diameter to allow for a multitude of different applications.

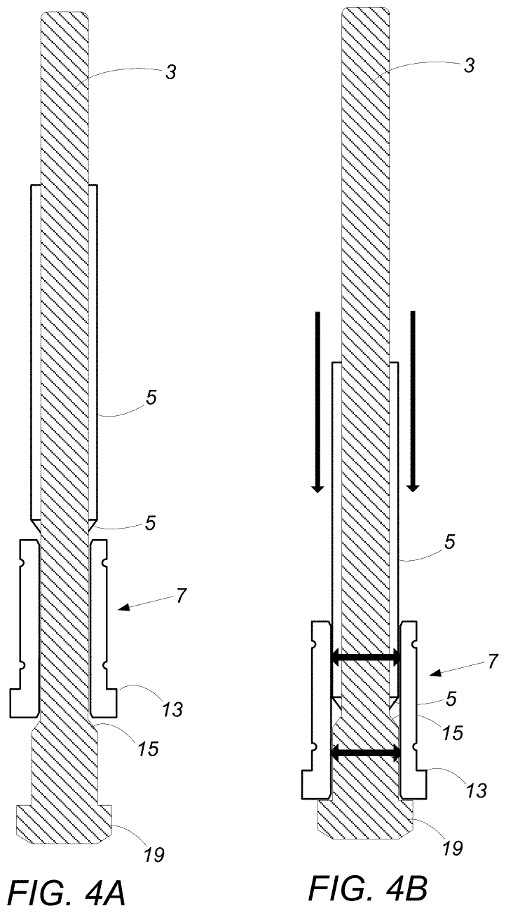

Continuing now with a better understanding of the expansion head 7, FIGS. 4A and 4B provide cross-sectional views of the bearing extraction assembly 1 in different configurations in accordance with embodiments of the disclosed principles. In particular, FIG. 4A is a cross-sectional view of the bearing extraction assembly when in the configuration shown in FIG. 1, with the extraction assembly head not expanded. Similarly, FIG. 4B is a cross-sectional view of the bearing extraction assembly when in the configuration shown in FIG. 2, with the extraction assembly head expanded by the sliding of the sleeve 5 and stop plug 19 together, expanding the extraction assembly head 7 via the sleeve 5 shoulder and the shoulder 15 of the expansion plug and onto the trunk 17, coming to rest against the stop 19.

As can be seen in FIGS. 4A and 4B, the inner edges of the extraction assembly head 7 may be slightly chamfered. This allows the segments of the extraction head 7 to more easily ride up on the shoulders of the sleeve 5 and the expansion plug 19 when they are forced together, expanding the head.

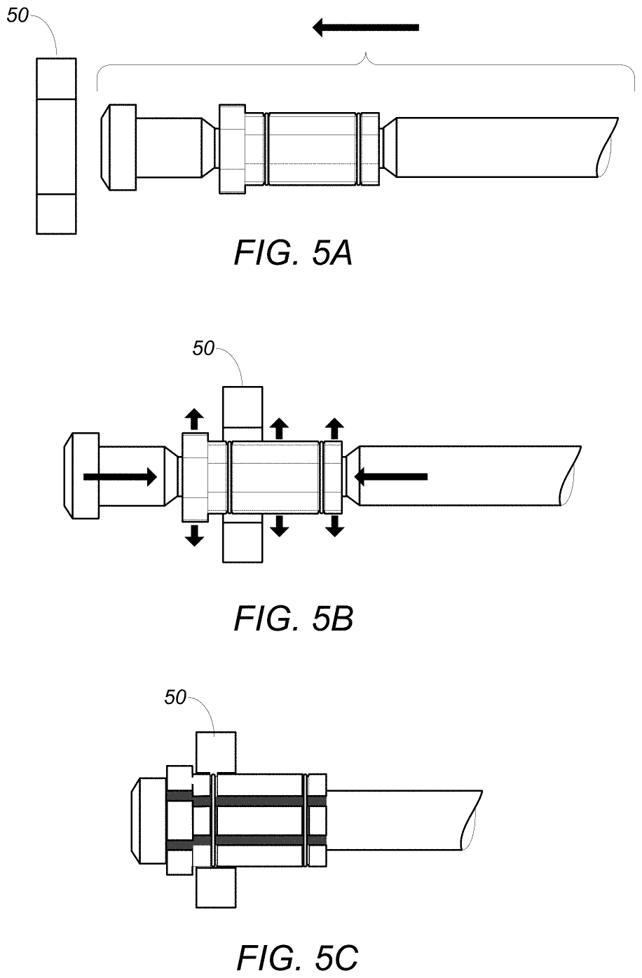

Given the foregoing description of the structure and function of the extraction assembly 1, and continuing now to FIGS. 5A-C, an example of the usage of the extraction assembly 1 is shown. FIG. 5A shows a perspective side view of the bearing extraction assembly 1 and a target bearing 50 in accordance with an embodiment of the disclosed principles. In this figure, the extraction assembly is outside the bearing and the extractor head is not expanded.

In FIG. 5B, the extraction assembly has been inserted through the middle of the bearing 50, such that the ledge 13 of the head 7 is beyond the back of the bearing 50, but the head 7 has not yet been expanded. Finally, FIG. 5C shows the extractor head 7 expanded (by pushing the sleeve 5 inward and pulling the expansion plug 19 outward) such that the ledge 13 of the head 7 is expanded behind the bearing and the body of the head 7 fits within the internal diameter of the bearing. From this configuration, the pulling of the extraction assembly will remove the bearing from its cavity (not shown).

Of note, these figures also show the substantial amount of overlap between the ledge of the head and the back surface of the bearing 50. In particular, instead of having two or three fingers or claws behind the bearing, as would be the case with slide hammer jaws, the head ledge is almost continuous, with the only gaps being the gaps left when the head expands. This provides immense strength, allowing the extraction assembly to be used not only for continuous threaded extraction mechanisms as shown, but also with slide hammer actuators and other high impact devices.

For impact use, it is preferred that at least the ledge portion of the head be hardened steel or other impact-tolerant material. Moreover, if threading is not used to provide leverage for extraction, then a non-threaded or only sparsely threaded rod may stand in for the illustrated threaded rod. For example, threads need only remain at the bottom end of the rod to attach the expansion plug and/or at the top end of the rod to attach another form of extraction power such as a slide hammer actuator portion.

In an embodiment of the disclosed principles, the extraction assembly is pulled by way of a threaded element such as a nut being screwed down the threaded rod 3 while being axially restrained, such as by a suitable bracket or washer against the component housing the bearing. The threaded rod provides a removal force that can be greater and more controllable than that provided by most slide hammers and the like, and enables removal of the bearing 50 with no damage to the bearing, the bearing cavity, or the housing component.

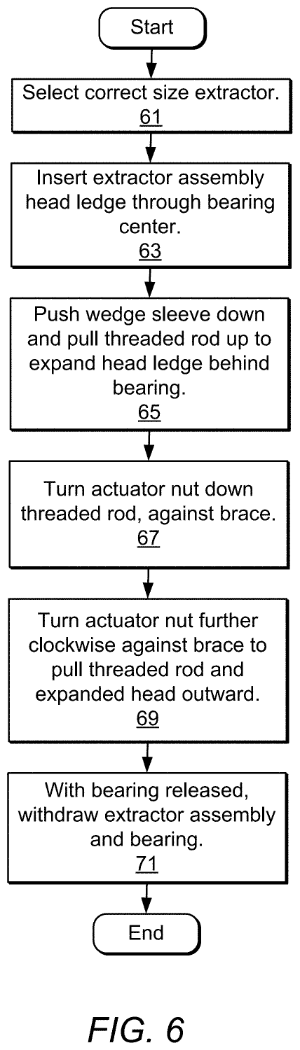

FIG. 6 is a flow chart showing a process of using a bearing extractor assembly in accordance with an embodiment of the disclosed principles. At stage 61, the correct size extractor is selected. In particular, the size of the extractor head should be selected such that the ledge of the unexpanded head will pass through the center of the bearing, and such that the ledge diameter exceeds the bearing inner diameter in the expanded state. It is also desirable though not required that the remainder of the head fit somewhat snugly against the inner surface of the bearing when in the expanded state.

At stage 63, the extractor assembly head ledge is inserted through the bearing center, and at stage 65, the sleeve is pushed down the threaded rod into head while the threaded rod is pulled outward, such that the two shoulders expand the head, including the ledge situated behind the bearing. An actuator nut is then threaded against a brace, down threaded rod at stage 67, and is further turned, e.g., clockwise, against the brace at stage 69 to pull the threaded rod, expanded head and entrapped bearing outward. When the bearing releases (stage 69), the entire assembly, with bearing, is pulled free of the associated component at stage 71. The technician is then free to service or replace the bearing or perform other work aided by removal of the bearing.

Regarding the brace or bracing fixture, the fixture needs to allow enough movement between it and the part being pulled to remove the part from its cavity. Further, the brace should hold the threaded rod centered so that it pulls the extractor head straight outward.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A bearing extraction tool comprising:
a threaded rod, the threaded rod having a top end and a bottom end, the threaded rod being at least partially threaded, the bottom end of the threaded rod comprising an expansion plug having a ramped shoulder, a trunk and a stop;
an expansion sleeve over a portion of the threaded rod, the expansion sleeve having a top end adjacent the top end of the threaded rod and a bottom end, the bottom end of the expansion sleeve comprising a ramped shoulder facing the ramped shoulder of the expansion plug; and
an expansion head between the expansion plug shoulder and the sleeve shoulder, the expansion head being substantially cylindrical with a ledge portion, and made up of multiple parallel segments, such that pushing the shoulder of the sleeve towards the shoulder of the expansion plug acts to expand the expansion head such that diameter of the expansion head other than the ledge portion is substantially the same as an inner diameter of a target bearing, and the diameter of the expansion head ledge portion exceeds the inner diameter of the target bearing, and such that subsequent outward movement of the bearing extraction tool serves to also move the bearing outward.

2. The bearing extraction tool in accordance with claim 1, further comprising a threaded nut threaded onto the threaded portion of the threaded rod, such that turning the threaded nut down the threaded rod when the expansion head is expanded causes outward movement of the bearing extraction tool.

3. The bearing extraction tool in accordance with claim 1, wherein at least the ledge portion of the expansion head is hardened steel or other impact-tolerant material.

4. The bearing extraction tool in accordance with claim 1, wherein at least the ledge portion of the expansion head comprises an impact-tolerant material other than steel.

5. The bearing extraction tool in accordance with claim 1, wherein the multiple parallel segments are chamfered on surfaces facing the shoulders of the sleeve and the bottom end.

6. The bearing extraction tool in accordance with claim 1, wherein the bottom end is internally threaded to thread onto the threaded rod.

7. A bearing extraction tool comprising:
a rod, the rod having a top end and a bottom end, the bottom end comprising an expansion plug having a ramped shoulder, a trunk and a stop;
an expansion sleeve over a portion of the rod, the expansion sleeve having a top end adjacent the top end of the rod and a bottom end, the bottom end of the expansion sleeve comprising a ramped shoulder facing the ramped shoulder of the expansion plug; and
an expansion head between the expansion plug shoulder and the sleeve shoulder, the expansion head being substantially cylindrical with a ledge portion, and made up of multiple parallel segments, such that pushing the shoulder of the sleeve towards the shoulder of the expansion plug acts to expand the expansion head such that diameter of the expansion head other than the ledge portion is substantially the same as an inner diameter of a target bearing, and the diameter of the expansion head ledge portion exceeds the inner diameter of the target bearing, and such that subsequent outward movement of the bearing extraction tool serves to also move the bearing outward.

8. The bearing extraction tool in accordance with claim 7, wherein the rod is at least partially threaded, the tool further comprising a threaded nut threaded onto a threaded portion of the threaded rod, such that turning the threaded nut down the threaded rod when the expansion head is expanded causes outward movement of the bearing extraction tool.

9. The bearing extraction tool in accordance with claim 7, wherein at least the ledge portion of the expansion head is hardened steel or other impact-tolerant material.

10. The bearing extraction tool in accordance with claim 7, wherein at least the ledge portion of the expansion head comprises an impact-tolerant material other than steel.

11. The bearing extraction tool in accordance with claim 7, wherein the multiple parallel segments are chamfered on surfaces facing the shoulders of the sleeve and the bottom end.

12. The bearing extraction tool in accordance with claim 1, wherein the rod is at least partially threaded and the bottom end is internally threaded to thread onto a threaded portion of the threaded rod.
